(19) United States
(12) Patent Application Publication
(10) Pub. No.: US 2026/0326364 A1
(43) Pub. Date: Oct. 22, 2026

(54) RESIN MOLDED PRODUCT MAKING SINK MARKS ON APPEARANCE SURFACE VISUALLY INCONSPICUOUS, AND DEVICES USING THE SAME TO CONSTITUTE APPEARANCE SURFACES OF THE DEVICES

(71) Applicant: BROTHER KOGYO KABUSHIKI KAISHA, Nagoya (JP)

(72) Inventors: Katsuo KOMATSU, Machida (JP); Shohei HIGUCHI, Iwakura (JP); Takaaki OGUCHI, Nagoya (JP); Yasuomi JIBU, Ichinomiya (JP); Hitoshi FUJINO, Tajimi (JP)

(73) Assignee: BROTHER KOGYO KABUSHIKI KAISHA, Nagoya (JP)

(21) Appl. No.: 19/645,440

(22) Filed: Apr. 13, 2026

Related U.S. Application Data
(63) Continuation of application No. PCT/JP2024/036438, filed on Oct. 11, 2024.

(30) Foreign Application Priority Data
Oct. 16, 2023 (JP) 2023-178131

(51) Int. Cl. B29C 59/00; B29L 31/00

(52) U.S. Cl. CPC B29C 59/002; B29L 2031/722; B29L 2031/758; B29L 2031/767

(57) ABSTRACT

A resin molded product includes a plate portion and a plurality of upstanding portions. The plate portion has a first surface and a second surface opposite each other. The first surface serves as an appearance surface of the resin molded product. The first surface has a plurality of pattern-unit portions arranged in rows to form a pattern of concaves and convexes on the first surface. The upstanding portions extend from the second surface of the plate portion. The resin molded product satisfies the following conditions: H/(t×L×a)>0.0326 ln(t×L×a)−0.0305; and t×L×a≥1.8, in which: H represents a height of the pattern-unit portions; t represents a wall thickness of the plate portion; L represents a maximum wall thickness of the upstanding portions; and a represents a shrinkage rate of resin.

### REFERENCE TO RELATED APPLICATIONS

This is a by-pass continuation application of International Application No. PCT/JP2024/036438 filed Oct. 11, 2024 claiming priority from Japanese Patent Application No. 2023-178131 filed Oct. 16, 2023. The entire contents of the International Application and the priority application are incorporated herein by reference.

### BACKGROUND ART

In a known printer, a rear cover is configured as a resin molded product. In this technology, a maintenance base arranged at a home position of an ink head is integrally formed with the resin molded rear cover.

### SUMMARY

Resin molded products are often injection molded using such resin materials as polyolefin resin, polystyrene resin, acrylonitrile butadiene styrene (ABS) resin, high-impact polystyrene (HIPS) resin, polycarbonate resin, and polyamide resin. Resin molded products formed by injection molding may develop sink marks, which are depressions caused by volume shrinkage of the resin during molding. Sink marks are particularly prone to forming on the undersides of bosses or ribs when the resin molded product has such bosses or ribs. Sink marks visually discernible in the aesthetic surface of a resin molded product in particular detract from the aesthetic appearance and significantly reduce marketability of the product.

In view of the foregoing, it is an object of the present disclosure to provide resin molded products that can eliminate visually conspicuous sink marks produced during molding to reduce deterioration in appearance. It is another object of the present disclosure to provide printing devices, sewing machines, karaoke systems, and karaoke remote control devices that utilize these resin molded products.

In order to attain the above and other objects, according to one aspect, the present disclosure provides a resin molded product including a plate portion and a plurality of upstanding portions. The plate portion has a first surface and a second surface opposite each other. The first surface includes a plurality of pattern-unit portions arranged in rows to form a pattern of concaves and convexes on the first surface. The first surface serves as an appearance surface of the resin molded product. The plurality of upstanding portions extend from the second surface of the plate portion. In this resin molded product, the following conditions are met: H/(t×L×a)>0.0326 ln(t×L×a)−0.0305; and t×L×a≥1.8, in which: H represents a height of the pattern-unit portions; t represents a wall thickness of the plate portion; L represents a maximum wall thickness of the plurality of upstanding portions; and a represents a shrinkage rate of resin.

The inventors of the present disclosure molded resin molded products having the plate portion and the upstanding portions under various conditions. In so doing, the inventors also performed surface finishing on molds while varying various parameters and conducted sensory evaluations on the appearance of sink marks after this finishing. As a result, the inventors discovered that forming, as a surface finishing process, texture consisting of a plurality of pattern-unit portions (each having an appropriate height) such that the pattern-unit portions are arranged in rows on the appearance surface of the plate portion was effective in reducing the obtrusive appearance of sink marks produced in the plate portion.

In a case where the plate portion is simply finished as a smooth surface, specularly reflected light is only incident on a user's eye under specific relative positions between the light source and the user's eye. Consequently, shadows caused by the presence of sink marks become clearly apparent visually. In contrast, in a case where multiple pattern-unit portions are arranged on the appearance surface of the plate portion, where each pattern-unit portion has the above-described predetermined concave/convex shape as a single unit, specularly reflected light is generated from each concave or convex in each pattern-unit portion, and all of this light is incident on the user's eye. As a result, luminance distribution becomes uniform across the entire surface of the entire plate portion on which the pattern-unit portions are arranged in rows, thereby reducing shadows caused by the presence of sink marks.

Specifically, the inventors discovered that sink marks generated in the plate portion could be less visually noticeable through a specific structure that satisfies the following conditions: H/(t×L×a)>0.0326 ln(t×L×a)−0.0305; and t×L×a≥1.8, where H represents the height of the pattern-unit portions; t represents the wall thickness of the plate portion; L represents the maximum wall thickness among the upstanding portions; and a represents the shrinkage rate of the resin.

Sink marks can be made visually less recognizable by performing surface finishing that satisfies the numerical range conditions described above. As a result, a deterioration in the aesthetic appearance can be reduced, thereby reducing a deterioration in marketability.

### BRIEF DESCRIPTION OF DRAWINGS

FIG. 1A is a perspective view of a test piece used for an experiment according to a first embodiment when viewed from its front side.

FIG. 1B is a perspective view of the test piece used for the experiment according to the first embodiment when viewed from its back side.

FIG. 2 shows one example of results obtained from stitching measurements of the surface of the test piece with a microscopic measuring tool.

FIG. 3 is a graph showing how a sink mark depth changes when a wall thickness of a plate portion of the test piece is varied.

FIG. 4 is a graph showing how the sink mark depth changes when a wall thickness of a boss of the test piece is varied.

FIG. 5 is a graph showing how the sink mark depth changes when a height of the boss of the test piece is varied.

FIG. 6 is a graph showing how the sink mark depth changes when a holding pressure during molding of the test piece is varied.

FIGS. 7A and 7B show how the appearance of the test piece is affected when sink marks are produced.

FIG. 8A shows an overall top view of an improved test piece configured with a plate portion having a texture pattern.

FIG. 8B is an enlarged view of a featured portion of the texture pattern of the improved test piece.

FIGS. 9A through 9G are explanatory views to show a method of designing one example of the texture pattern configured of multiple pattern-unit portions to be formed on the plate portion of the test piece.

FIG. 10A shows an example of the method of designing the pattern-unit portion.

FIG. 10B shows another example of the method of designing the pattern-unit portion.

FIG. 11A shows still another example of the method of designing the pattern-unit portion.

FIG. 11B shows still another example of the method of designing the pattern-unit portion.

FIG. 12A is an explanatory view to illustrate how specularly reflected light is visible when a test piece has a planar surface.

FIG. 12B is an explanatory view to illustrate how specularly reflected light is visible when a test piece has a surface with concave/convex textures configured by spherical surfaces.

FIG. 13A shows a test piece without embossing having the plate portion with concave/convex textures configured by multiple pattern-unit portions.

FIG. 13B shows a test piece with embossing having the plate portion with concave/convex textures configured by multiple pattern-unit portions.

FIG. 14 is a graph organizing all the experimental results for the sink mark depth and the height of the pattern-unit portions on the test piece.

FIGS. 15A and 15B illustrate various dimensions of the plate portion on which concave-shaped pattern-unit portions are formed.

FIGS. 15C and 15D illustrate various dimensions of the plate portion on which convex-shaped pattern-unit portions are formed.

FIG. 16 shows an example of a test piece whose experimental data indicates that sink marks are visually discernible.

FIG. 17 shows an example of a test piece whose experimental data indicates that sink marks are largely eliminated.

FIG. 18 shows an example of a test piece whose experimental data indicates that sink marks are completely eliminated.

FIGS. 19A through 19C are graphs showing intensity of correlation between the sink mark depth and each variable “t×L×a”, “t+L+a” or “(tLa)^{½}”.

FIG. 20 shows a graph showing all the experimental results, where the horizontal axis x represents t×L×a on a logarithmic scale, and the vertical axis y represents the height of the pattern-unit portions divided by (t×L×a).

FIG. 21 is a graph showing the results of a survey to inquire whether sink marks are found to be obtrusive or not based on test pieces formed under various conditions for producing texture pattens configured of multiple pattern-unit portions and subjected to embossing.

FIGS. 22A to 22C show examples of variations of the shapes constituting each pattern-unit portion.

FIG. 23 is a perspective view illustrating the appearance of a printing device according to a second embodiment.

FIG. 24 is a cross-sectional view of the printing device taken along a plane XXIV-XXIV shown in FIG. 23.

FIG. 25 is a view illustrating an exemplary method of using the printing device.

FIG. 26 is a perspective view illustrating the appearance of a sewing machine according to a third embodiment.

FIG. 27 is a view illustrating the overall configuration of a karaoke system according to a fourth embodiment.

FIG. 28 is a view illustrating the appearance of a remote control device for the karaoke system according to a fifth embodiment.

### DESCRIPTION

Hereinafter, embodiments of the present disclosure will be described while referring to the accompanying drawings.

### First Embodiment

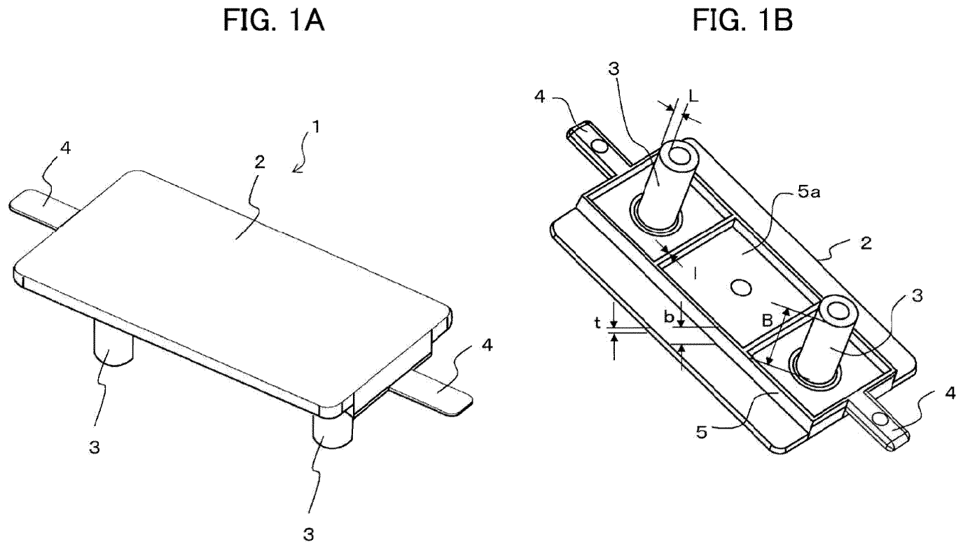

A first embodiment will be described with reference to FIGS. 1A through 22C.

### Instances of Molding Defects

In general, methods of molding resins include injection molding, blow molding, extrusion, vacuum forming, and other techniques. For example, conceivably, resin molded products formed through injection molding may develop molding defects such as sink marks, weld lines, color variation, texture variation, silver streaks, jetting, and flow marks.

### Measures to Address Deterioration in Appearance Quality

The appearance quality of a molded product suffers significantly when the above molding defects occur. One method for ensuring an aesthetically pleasing appearance is to perform a known secondary processing method, such as painting, plating, or polishing of the molded product. However, conceivably, performing secondary processes could increase costs due to the additional steps.

Other techniques for ensuring a good aesthetic appearance involve making modifications to the molding machine or the mold itself. Examples of these techniques include heat-and-cool molding, gas-assisted molding, and supercritical foam molding.

However, all of these techniques require auxiliary equipment, necessitating a significant capital investment. Such extended molding cycle times could increase production costs.

Therefore, the inventors and others involved in the present disclosure (hereinafter simply “the inventors of the present disclosure”) conducted studies to address the above concerns and obtained the findings described below. These findings are described next in detail.

### Formation Behavior of Sink Marks

First, the inventors of the present disclosure narrowed the focus of their investigation to sink marks, which of all of the molding defects described above have the greatest impact on appearance quality, and conducted experiments to study the formation behavior of sink marks. FIG. 1 illustrates a test piece 1 used in these experiments.

As illustrated in FIG. 1, the test piece 1 includes a plate portion 2, two bosses 3, two gate portions 4, and a rib 5.

The plate portion 2 has a general rectangular plate shape with a substantially uniform thickness. In other words, portions in the mold for manufacturing the plate portion 2 that define the thickness of the plate portion 2 are substantially uniform in dimension (the same applies hereinafter). The bosses 3 are disposed on the underside surface of the plate portion 2 so as to protrude substantially perpendicular thereto. The bosses 3 are arranged in a longitudinal direction of the plate portion 2, with one boss portion 3 on one side in the longitudinal direction and the other boss portion 3 on the other side in the longitudinal direction. The rib 5 is a rectangular-shaped frame that includes a bottom portion 5a and is disposed on the underside of the plate portion 2 so as to surround the base end of each of the two bosses 3.

The two gate portions 4 are integrally arranged on the rib 5. One of the gate portions 4 is disposed on one end of the rib 5 in the longitudinal direction of the plate portion 2 and protrudes outward therefrom toward the one side in the longitudinal direction. The other gate portion 4 is disposed on the other end of the rib 5 in the longitudinal direction of the plate portion 2 and protrudes outward therefrom toward the other side in the longitudinal direction.

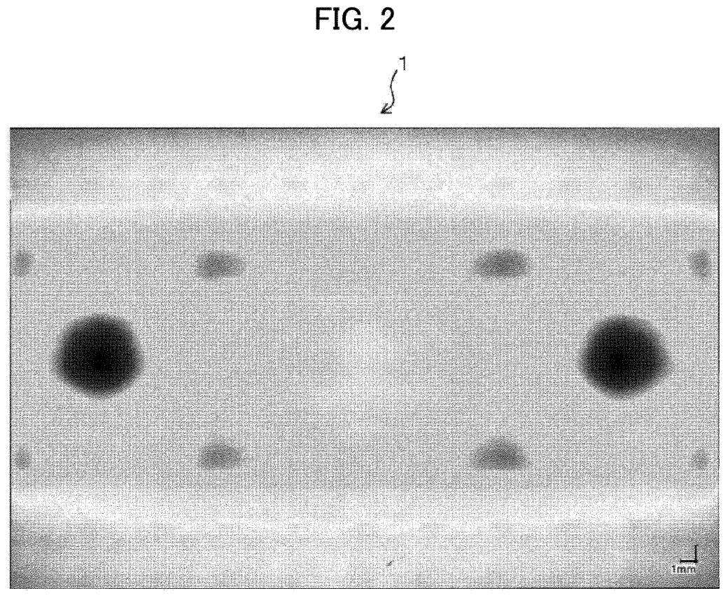

When the test piece 1 described above is produced through injection molding, sink marks appear on the underside surface of the plate portion 2 due to the presence of the bosses 3 and the rib 5. FIG. 2 shows one example of results obtained from stitching measurements of the top surface of the test piece 1 with a microscopic measuring tool. In this example, coloration that differs from that in other areas appears in areas corresponding to the two left and right bosses 3 and areas corresponding to the rectangular frame-shaped rib 5, revealing that sink marks are formed in these areas.

In these experiments, the inventors of the present disclosure created the test piece 1 using polystyrene (PS) or polypropylene (PP) as the test piece material. The inventors of the present disclosure used a flow analysis technique to determine the presence of sink marks and to find a sink mark depth D [mm] of the sink marks that were formed. The range of combinations for analysis conditions is as follows.

Shrinkage rate a of PS=0.4 to 0.7 [%]

Shrinkage rate a of PP=1.0 to 2.5 [%]

Holding pressure P=10 [MPa], 80 [MPa], 100 [MPa], 110 [MPa], and 120 [MPa]

Dimensions of the test piece 1:
Design wall thickness t of the plate portion 2=0.5 [mm], 2.3 [mm], 4 [mm], and 5 [mm]
Design wall thickness L of the bosses 3=1.74 [mm], 3 [mm], 3.5 [mm], and 4 [mm]
Design height B of the bosses 3=10 [mm], 13.9 [mm], 20 [mm], and 30 [mm]
Design wall thickness I of the rib 5=1.0 [mm]
Design height b of the rib 5=1.9 [mm]

### Effects of Each Parameter on Sink Mark Depth D

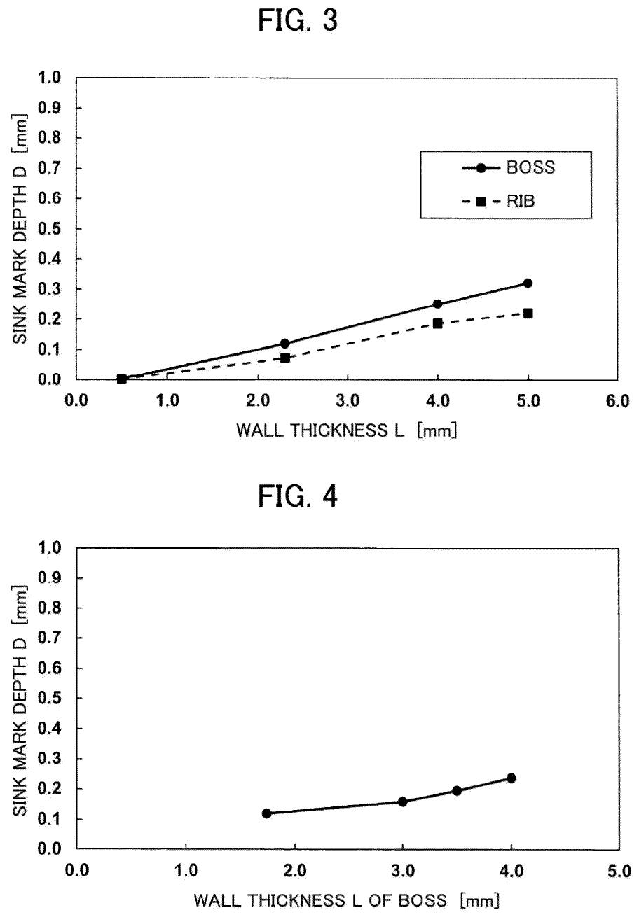

FIGS. 3 through 6 show examples of the effects that these parameters have on the sink mark depth D based on the above experimental results.

FIG. 3 is a graph showing how the sink mark depth D changes when the wall thickness t of the plate portion 2 is varied. In this case, the wall thicknesses of the bosses 3 and the rib 5 are 1.74 [mm] and 1.0 [mm], respectively, and the design height of the bosses 3 and the rib 5 are 13.9 [mm] and 1.9 [mm], respectively. PP was used as the material of the test piece and the molding conditions were kept constant. As shown, the sink mark depth D at the bosses 3 increases monotonically from 0 to 0.32 [mm] and the sink mark depth D at the rib 5 increases monotonically from 0 to 0.22 [mm] within the wall thickness range of 0.5 to 5.0 [mm]. Since the difference in sink mark variation behavior between the bosses 3 and the rib 5 is negligible when considering the difference in wall thickness between the bosses 3 and the rib 5, the experiments described below in FIGS. 4 through 6 focus solely on the bosses 3.

FIG. 4 is a graph showing the variation in sink mark depth D when the wall thickness L of the bosses 3 is varied. As shown, the sink mark depth D at the bosses 3 increases monotonically from 0.12 to 0.24 [mm] within the range of the wall thicknesses L from 1.74 to 4.0 [mm].

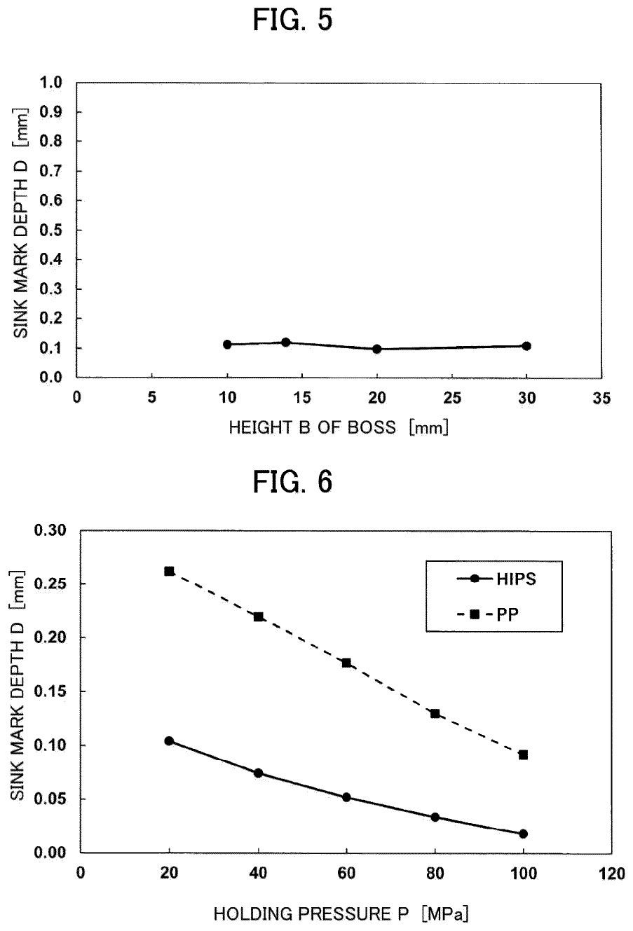

FIG. 5 is a graph showing the variation in sink mark depth D when the height B of the bosses 3 is varied. As shown, the sink mark depth D at the bosses 3 ranges from 0.11 to 0.1 [mm] within the range of heights B from 10 to 30 [mm], indicating that the sink mark depth D remains virtually unchanged.

FIG. 6 is a graph showing variations in the sink mark depth D when the holding pressure P during molding is varied. As shown, the sink mark depth D decreases monotonically from 0.26 to 0.09 [mm] in the case of PS and decreases monotonically from 0.1 to 0.01 [mm] in the case of PP within the range of holding pressures P from 20 to 100 [MPa].

### Examples of How Sink Marks Affect Appearance

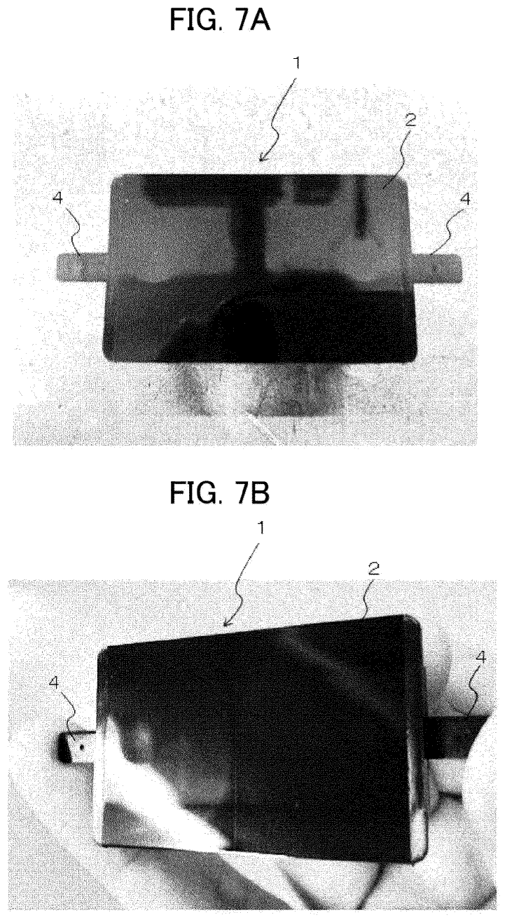

FIGS. 7A and 7B show how the appearance of the test piece 1 is affected when sink marks are produced, as described above. When not performing a surface process such as that described later, the shadows of sink marks are clearly visible in locations corresponding to the underside surfaces of the bosses 3 and the rib 5, as illustrated in FIGS. 7A and 7B. This is partly due to a significant difference in brightness within the surface, owing to such factors as specularly reflected light becoming visible or not visible when varying the angle at which the test piece 1 is viewed. FIG. 7B shows specular reflection from a streak of light projected onto the test piece 1, making the sink marks more visually apparent.

### Considerations of Reflected Light

Generally, the total reflected light consists of specular reflection and diffuse reflection. By considering specularly reflected light and diffusely reflected light together, the luminance of the total reflected light can be predicted.

The luminance distribution of specular reflection can be calculated with a Phong model, commonly used in ray tracing and other techniques. The distribution of luminance from specular reflection is calculated according to the reflection vector and the view vector, where luminance is maximum when the reflection vector equals the view vector.

The luminance distribution of diffuse light, on the other hand, can be calculated using a Lambertian model, which is commonly employed in ray tracing and other techniques. Diffused light has the same luminance regardless of the viewing direction. Embossing is one example of a process designed to achieve this diffusion phenomenon.

For example, consider a case in which the light source and the viewpoint are fixed while the molded product is moved. When the surface of the molded product has irregularities, steps, or curvature, the normal vector will vary. A normal vector is a unit vector perpendicular to the tangent plane. For a curved surface, the normal vector changes continuously since the tangent plane to the curved surface changes continuously. Consequently, the relationship between the reflection angle and the view vector in the Phong model changes, leading to a perception of uneven brightness that facilitates the viewer in perceiving irregularities such as bumps, steps, and curves.

The inventors of the present disclosure had the idea that, if the brightness of total reflection could be distributed uniformly across the entire surface, shadows resulting from steps or curves in the reflecting surface caused by molding defects would be difficult to perceive. Assume, for example, that textural formations configured of curved surfaces were formed on the surface of a molded product. Even though the normal vector changes due to unevenness, steps, or curvature in the surface of the molded product, the normal vector would also change along the curved surfaces in each unit constituting the textural formations. This would reduce changes in luminance for each unit in the textural formations, producing a uniform distribution of luminance across the entire surface. Such a uniform distribution would likely make unevenness, steps, and curvature caused by molding defects more difficult to perceive.

### Formation of Textures

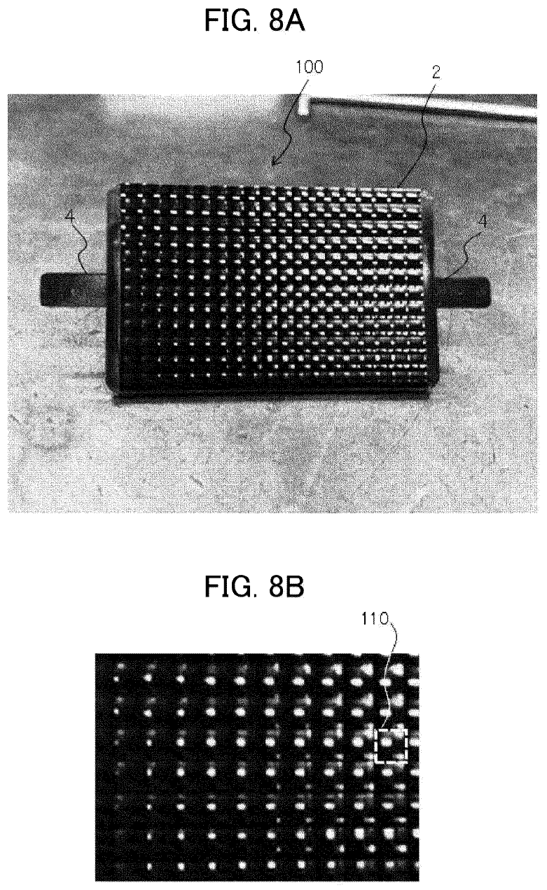

Based on the above considerations, FIG. 8A shows an overall top view of an improved test piece 100 configured with a plate portion 2 having textural formations, and FIG. 8B shows an enlarged view of a featured portion of the textural formations. As shown in FIGS. 8A and 8B, the test piece 100 has texture on the plate portion 2 of the test piece 1 illustrated in FIGS. 1A and 1B. The texture (a pattern of concaves and convexes) is formed by performing a surface process on the plate portion 2 to produce multiple pattern-unit portions 110 arranged in rows in the surface of the plate portion 2.

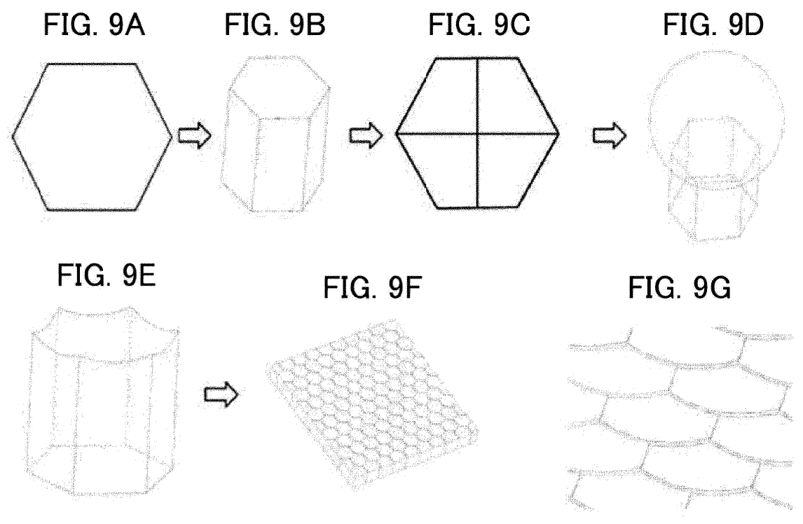

The method of designing a texture to be formed on the plate portion 2 of the test piece 100 will be described with reference to FIGS. 9A through 9G.

As shown in FIG. 9A, first a unit figure that will serve as the contour is drawn. A regular hexagon is used as an example in this drawing.

Next, the drawn unit figure is extruded to an arbitrary thickness in the vertical direction, as illustrated in FIG. 9B.

Then, the center point of a spherical surface is sketched within the space formed by the extrusion described above (inside the regular hexagonal prism in this example) as illustrated in FIG. 9C.

Subsequently, a sphere is positioned so as to contact the sketched point described above, as illustrated in FIG. 9D.

Next, by subtracting coordinates to offset the sphere arranged as described above by the dimension of the maximum sink mark depth D, the shape of the pattern-unit portions 110 is determined, as illustrated in FIG. 9E.

Subsequently, the surface profile of the plate portion 2 is completed by adding and arranging a plurality of the pattern-unit portions 110 in rows over the required area, as illustrated in FIG. 9F. Note that the contours of the textural formations can be emphasized during the above process by offsetting the centers of the spheres or by introducing gaps to create steps when arranging the pattern-unit portions 110, as illustrated in FIG. 9G.

### Sample Shapes of the Pattern-Unit Portions 110

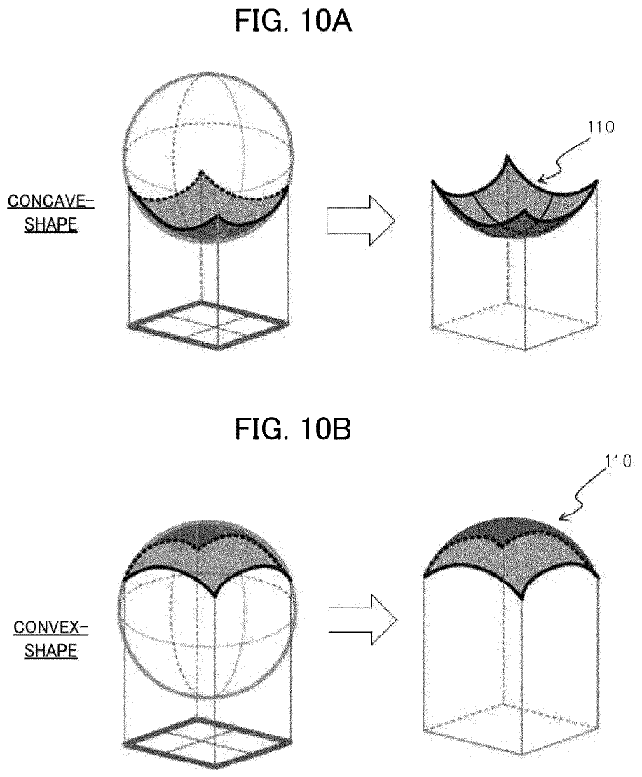

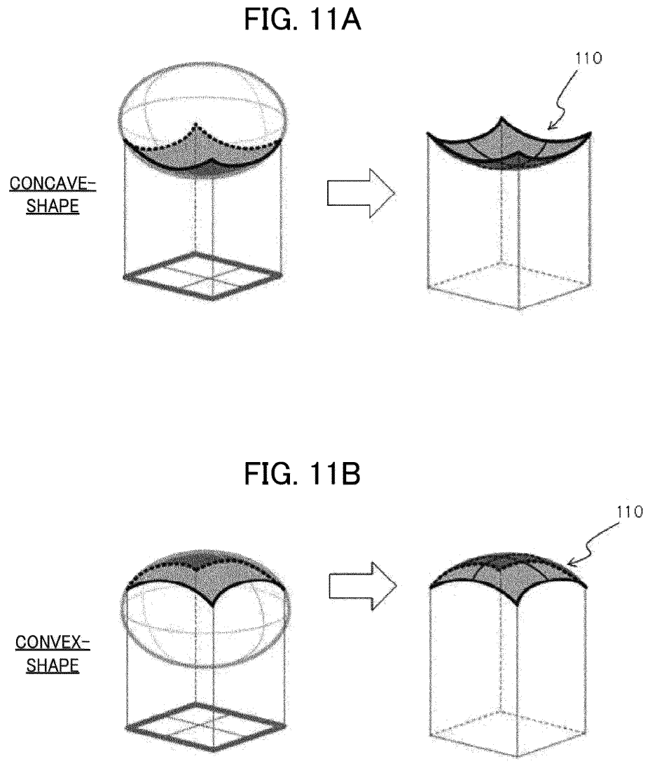

FIGS. 10A through 11B illustrate examples of the pattern-unit portions 110 designed as described above.

FIG. 10A illustrates an example of the pattern-unit portion 110 formed according to the technique described above in FIGS. 9A through 9G. This pattern-unit portion 110 has a concave shape formed using a spherical surface to cut into the top surface of a rectangular parallelepiped. FIG. 10B illustrates another example of the pattern-unit portion 110 formed into a convex shape by the top portion of the spherical surface, which is the inverse of the above-described shape of FIG. 10A.

FIGS. 11A and 11B illustrate an example of applying an ellipse to the configuration of FIGS. 10A and 10B. FIG. 11A illustrates an example of the pattern-unit portion 110 formed into a convex shape using an ellipsoid to cut into the top surface of a rectangular parallelepiped. FIG. 11B illustrates an example of the pattern-unit portion 110 formed into a convex shape by the top portion of the ellipsoid, which is the inverse of the above-described shape of FIG. 11A.

Note that both the pattern-unit portions 110 formed utilizing a spherical surface, as illustrated in FIGS. 10A and 10B, and the pattern-unit portions 110 formed utilizing an ellipsoid, as illustrated in FIGS. 11A and 11B, are examples of ‘curved surface’ of the disclosure.

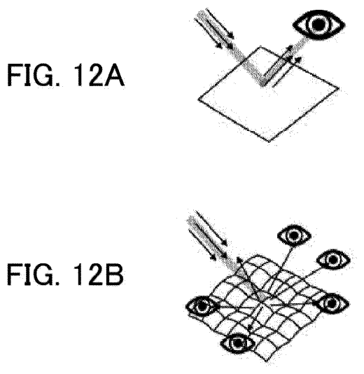

When the surface of a test piece has a planar shape, as in the test piece 1 described above, specularly reflected light is only visible under specific positional relationships between the light source and the observer's eye, as illustrated in FIG. 12A. Therefore, the differences in brightness described above are produced in the surface of the test piece 1, as illustrated in FIG. 7B. In contrast, when the surfaces have pattern-unit portions 110 configured by spherical surfaces, as with the test piece 100 described above, specularly reflected light is more likely to be included in reflection from each pattern-unit portion 110, as illustrated in FIG. 12B. As a result, the inventors discovered that luminance distribution becomes uniform across the entire surface of the test piece 100 and that shadows from sink marks become virtually invisible, as illustrated in FIGS. 8A and 8B.

### Addition of an Embossing Process

The inventors of the present disclosure further created a test piece 200 by applying a known embossing process to the plate portion 2 of the test piece 100 in which the pattern-unit portions 110 were formed as described above. The test pieces 100 and 200 are examples of ‘resin molded product’ of the disclosure.

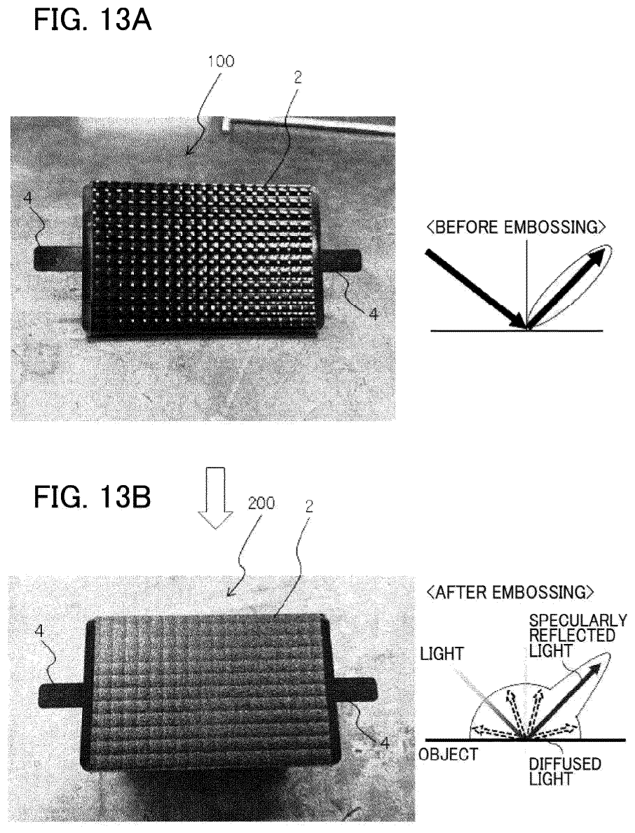

As can be seen by comparing the test piece 100 before embossing, as shown in FIG. 13A, with the embossed test piece 200 shown in FIG. 13B, the inventors discovered that shadows were further eliminated so that molding defects were reliably made less noticeable. In particular, the inventors of the present disclosure found that shadows were more reliably removed than when using a conventional method of embossing a plain flat surface similar to the plate portion 2 in FIG. 7A. This is likely because specularly reflected light from each pattern-unit portion 110 is diffused by the embossing in the configuration of FIG. 13B, as seen by comparing the explanatory diagrams to the right of FIGS. 13A and 13B.

### Establishment of a Numerical Range for Each Parameter

Based on the above studies and their findings, the inventors of the present disclosure further examined the numerical ranges of parameters necessary to achieve the above-described effect of eliminating shadows caused by sink marks as a visual effect for the viewer.

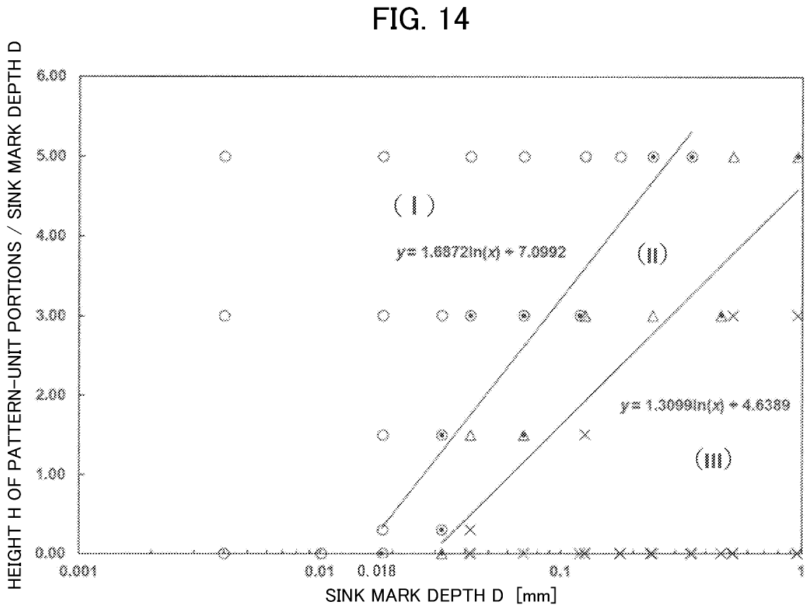

FIG. 14 shows a graph organizing the experimental results obtained using the numerical ranges described above for a height H and a sink mark depth D of the pattern-unit portions 110 on the test piece 200. In FIG. 14, the sink mark depth D [mm] is plotted on the horizontal axis x using a logarithmic scale, while the height H of the pattern-unit portion 110 divided by the sink mark depth D is plotted on the vertical axis y.

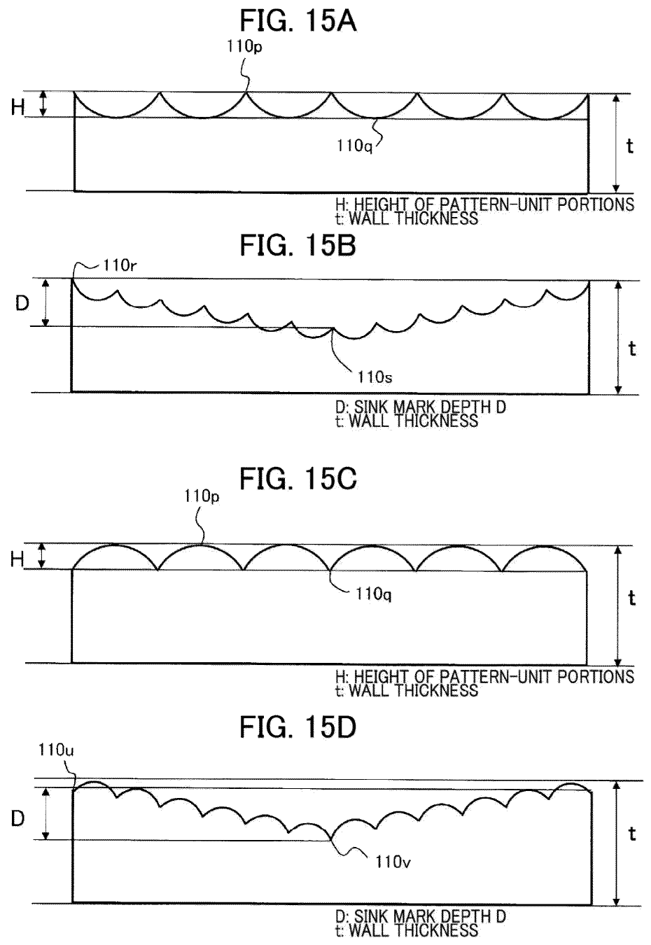

FIGS. 15A through 15D illustrate the dimensions for the height H of the pattern-unit portions 110, the sink mark depth D, and the wall thickness t described above.

FIGS. 15A and 15B represent definitions for various parts of the plate portion 2 on which the concave-shaped pattern-unit portions 110 described above are formed. FIG. 15A illustrates the wall thickness t of the plate portion 2 and the height H of the pattern-unit portions 110 defined when no sink marks have been produced, while FIG. 15B illustrates the wall thickness t of the plate portion 2 and the sink mark depth D defined when sink marks have been produced.

FIGS. 15C and 15D represent definitions for various parts of the plate portion 2 on which are formed the convex-shaped pattern-unit portions 110 described above. FIG. 15C illustrates the wall thickness t and the height H of the pattern-unit portions 110 defined when no sink marks have been produced, and FIG. 15D illustrates the wall thickness t and the sink mark depth D defined when sink marks have been produced.

The height H of the pattern-unit portions 110 is defined as the distance between a highest point 110p and a lowest point 110q of the pattern-unit portions 110, for example.

The sink mark depth D is defined as the depth of the depression produced in the outer surface of the plate portion 2 due to the sink mark phenomenon, relative to the outer surface unaffected by the sink mark phenomenon, for example.

In FIG. 15B, the sink mark depth D is set to the distance between a highest point 110r of the concave-shaped pattern-unit portions 110 formed in the outer surface of the plate portion 2 that is unaffected by the sink mark phenomenon, and a highest point 110s of the concave-shaped pattern-unit portions 110 formed in the deepest part of the depression generated in the outer surface due to the sink mark phenomenon.

The sink mark depth D in FIG. 15D, on the other hand, is set to the distance between a lowest point 110u of the convex-shaped pattern-unit portion 110 formed in the outer surface of the plate portion 2 unaffected by the sink mark phenomenon, and a lowest point 110v of the convex-shaped pattern-unit portions 110 formed in the deepest part of the depression generated in the outer surface due to the sink mark phenomenon.

### Methods of Measuring Dimensions

Examples of methods for measuring each of the above dimensions will be described next.

One method of measuring the wall thickness t of the plate portion 2 and the maximum wall thickness L among the bosses 3 and rib 5 involves using a general-purpose instrument such as calipers or a micrometer to measure a wall thickness of a molded part's cross section. However, when the plate portion 2 has a curved surface, it is necessary to use a ball micrometer or similar instrument with dual spherical faces and take care to ensure that the measuring tips of the instrument make point contact or line contact with the molded product. In addition to the measurement methods using the above general-purpose measuring instruments, measurement methods using contact or noncontact coordinate measuring machines can be employed to measure the wall thicknesses.

For the height H of the pattern-unit portions 110, on the other hand, a reference plane must be defined in order to determine the distance between the highest point and the lowest point of the pattern-unit portions 110. Therefore, measurements of the height H of the pattern-unit portions 110 can be categorized between cases in which the highest portion of the pattern-unit portions 110 has three or more points and cases in which the highest portion has two or fewer points.

In cases where the highest portion of the pattern-unit portions 110 includes three or more points, the coordinates of the three highest points are measured using the above coordinate measuring machine, and a reference plane passing through each of the highest points is calculated. Next, the coordinates of the lowest point are measured. One method sets the height H of the pattern-unit portions 110 to the distance between the coordinates of this lowest point and the reference plane in a direction orthogonal to the reference plane. An alternative method used when the plate portion 2 is planar is to measure three or more points on the planar portion 2 to calculate a reference plane.

In cases where the pattern-unit portions 110 have two or fewer highest points, on the other hand, the coordinates of the highest point for any one of the pattern-unit portions 110 among the multiple pattern-unit portions 110 arranged on the plate portion 2, and the coordinates of the highest points of the pattern-unit portions 110 neighboring this pattern-unit portion 110 are measured at three or more points to calculate a reference plane. However, a method similar to the case in which the pattern-unit portions 110 have three or more highest points may be employed to set the height H of the pattern-unit portions 110 to the distance between the highest and lowest points in the direction orthogonal to this reference plane. An alternative method used when the plate portion 2 is planar is to measure three or more points of the planar portion 2 to calculate a reference plane.

Returning to FIG. 14, each experimental data point plotted in FIG. 14 for the test piece 200 is sorted into one of three groups: those where sink marks are visually discernible; those where sink marks are largely eliminated; and those where sink marks are completely eliminated.

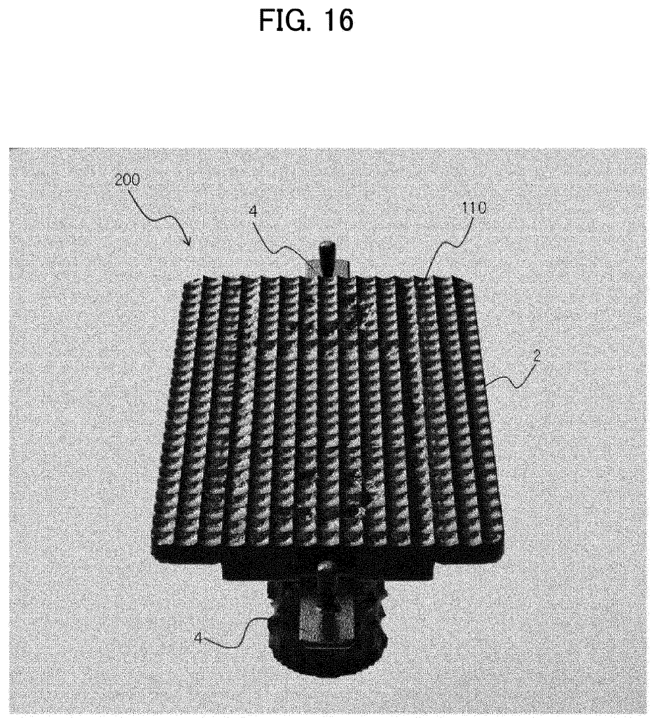

FIG. 16 shows an example of a test piece 200 having the experimental data represented by “×” in FIG. 14 to indicate that sink marks are visually discernible. As illustrated in FIG. 16, sink marks corresponding to the contour shapes of the two bosses 3 and the contour shape of the rectangular frame-like rib 5 on the underside surface are faintly visible through numerous pattern-unit portions 110 arranged on the plate portion 2.

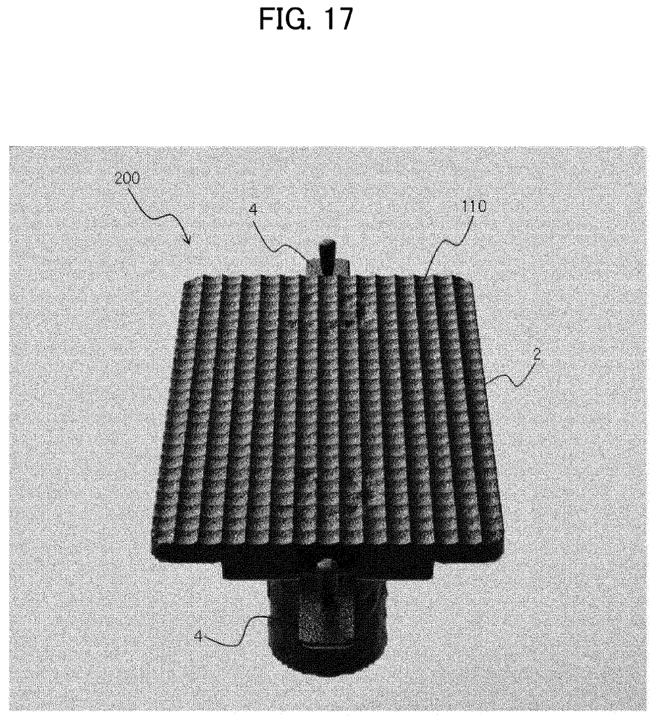

FIG. 17 shows an example of a test piece 200 whose experimental data is represented by “Δ” in FIG. 14 to indicate that the presence of sink marks is largely eliminated. As illustrated in FIG. 17, while the contour shapes of the two bosses 3 remain faintly discernible, the contour shape of the rib 5 disappeared and sink marks are largely eliminated across the entire plate portion 2.

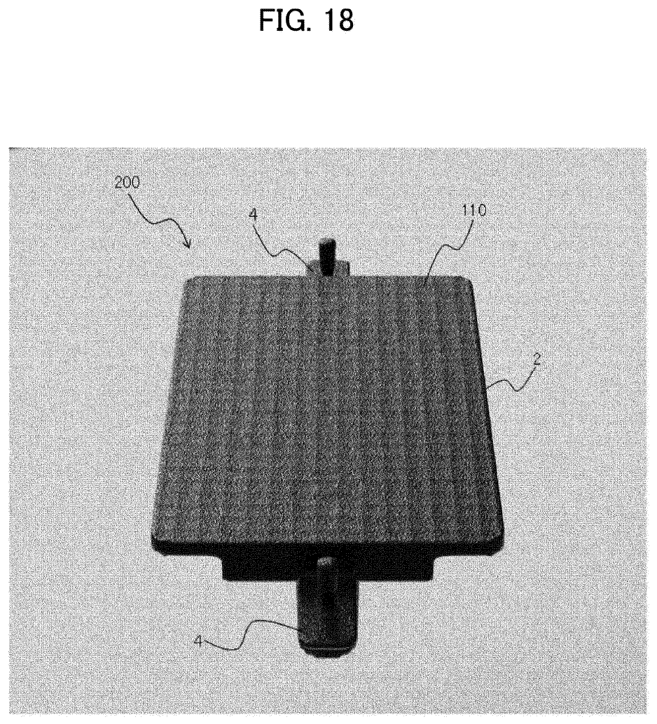

FIG. 18 shows an example of a test piece 200 whose experimental data is represented by “○” in FIG. 14 to indicate that the presence of sink marks is completely eliminated. As shown in FIG. 18, the contour shapes of the two bosses 3 and the rib 5 are both eliminated and sink marks are completely eliminated across the entire plate portion 2.

The inventors of the present disclosure learned that all experimental data shown in FIG. 14 is distributed into one of the following three regions: Region (I) in which data sets represented by “○” are present; Region (II) in which data sets represented by “Δ” are present ; and Region (III) in which data sets represented by “×” are present. The inventors also discovered that the boundary between the Regions (I) and (II) is represented by the following expression:

H/D=1.6872 ln(D)+7.0992, where D≥0.018 . . . (Expression 1),
while the boundary between the Regions (II) and (III) is represented by the following expression:

H/D=1.3099 ln(D)+4.6389, where D≥0.018 . . . (Expression 2).

### Definitions Without the use of Sink Mark Depth D

As described above with reference to FIG. 14, the degree to which specific parameters have an effect on eliminating sink marks could be defined based on the Regions (I), (II), and (III) into which the experimental results fall, where the horizontal axis x represents the sink mark depth D [mm] and the vertical axis y represents the height H of the pattern-unit portions 110 divided by the sink mark depth D. Since the sink mark depth D is a value that is difficult to measure or detect in practice, the inventors of the present disclosure considered other methods for performing similar definitions without the use of the sink mark depth D.

The inventors of the present disclosure focused on the above-described wall thickness t, wall thickness L, and shrinkage rate a pertaining to all experimental data in order to identify another parameter correlated with the sink mark depth D. Here, the larger of the wall thickness of the bosses 3 and the wall thickness of the rib 5, i.e., the maximum value, was used as the wall thickness L. Hereinafter, the bosses 3 and the rib 5 are collectively referred to as “upstanding portions 3” for convenience. The inventors then examined the strength of the variables “t×L×a”, “t+L+a”, and “(tLa)^{½}” relative to the sink mark depth D by calculating an approximation and a coefficient of determination R² for each variable using known methods.

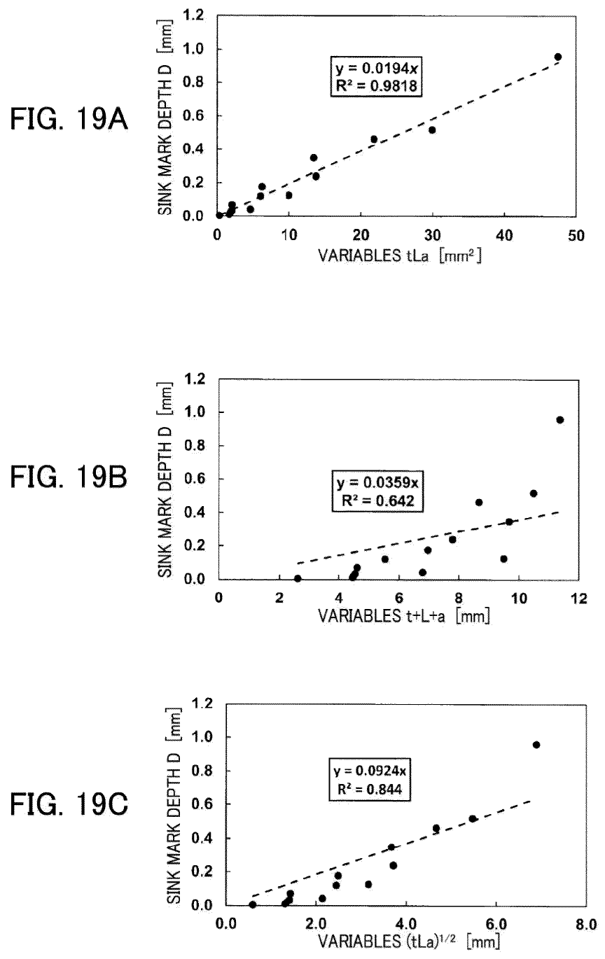

FIGS. 19A through 19C are graphs showing the results of this study. Here, the vertical axis y represents the sink mark depth D [mm], while the horizontal axis x represents “t×L×a” in FIG. 19A, “t+L+a” in FIG. 19B, and “(tLa)^{½}” in FIG. 19C.

In the graph of FIG. 19A, the approximation of the correlation between y=D [mm] and x=t×L×a [mm²] is represented as y=0.0194x, with a coefficient of determination R² of 0.9818. In the graph of FIG. 19B, the approximation of the correlation between y=D [mm] and x=t+L+a [mm] is represented as y=0.0359x, with a coefficient of determination R² of 0.642. In the graph of FIG. 19C, the approximation of the correlation between y=D [mm] and x=(tLa)^{½}[mm] is represented as y=0.0924x, with a coefficient of determination R² of 0.844.

The above result makes it clear that t×L×a, which has the largest coefficient of determination R², has the strongest correlation with the sink mark depth D. Accordingly, the sink mark depth D can be replaced with t×L×a using the following expression:

D=0.0194 (t×L×a) . . . (Expression 3)

### Replacement Graph

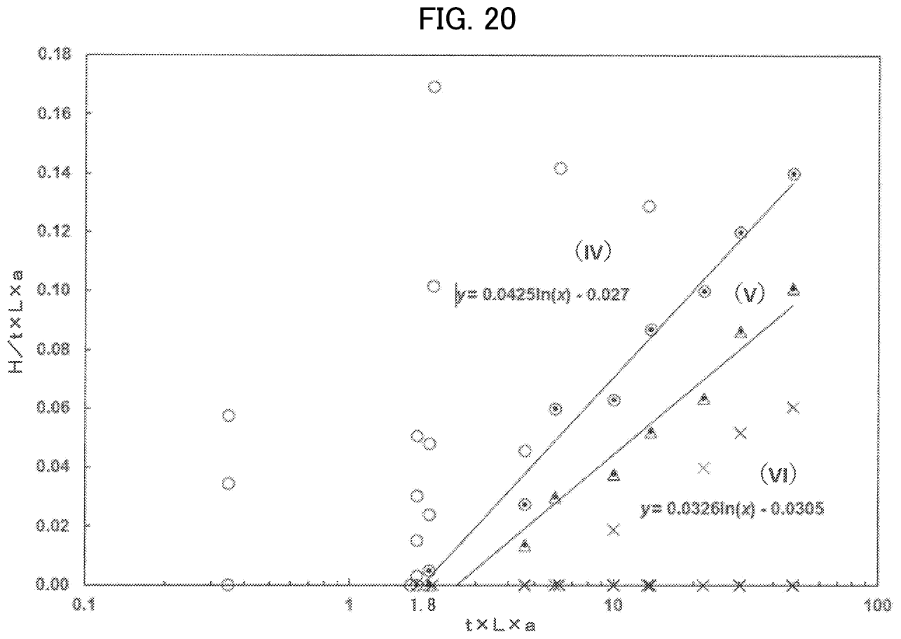

FIG. 20 shows a graph resulting from converting the experimental results shown in FIG. 14 described above using the Expression 3, where the horizontal axis x represents t×L×a on a logarithmic scale, and the vertical axis y represents the height H of the pattern-unit portions 110 divided by (t×L×a). The symbols “○”, “Δ”, and “×” for each data point in FIG. 20 are common to those in FIG. 14.

The inventors of the present disclosure discovered that the experimental data shown in FIG. 20 is distributed in one of the following three regions: Region (IV) corresponding to the Region (I) in FIG. 14 containing the set of data points having symbol “○”; Region (V) corresponding to the Region (II) in FIG. 14 containing the set of data points having symbol “Δ”; and Region (VI) corresponding to the Region (III) in FIG. 14 containing the set of data points having symbol “×”. As in the previous description, the inventors found that the boundary between the Regions (IV) and (V) is represented by the following expression:

H/(t×L×a)=0.0425 ln(t×L×a)−0.027 . . . (Expression 4), and
the boundary between the Regions (V) and (VI) is represented by the following expression:

H/(t×L×a)=0.0326 ln(t×L×a)−0.0305 . . . (Expression 5).

Based on the above results, the inventors of the present disclosure concluded that the range within which sink marks are substantially eliminated across the entire plate portion 2 of the test piece 200, obtaining the effect of reducing shadows caused by sink marks, is defined by the following expressions:

H/(t×L×a)>0.0326 ln(t×L×a)−0.0305 . . . (Expression 6); and

t×L×a≥1.8 . . . (Expression 7).

The technical significance of the Expression 7 is as follows.

The experimental data point marked “○” that was plotted at (x, y)=(1.8, 0) in FIG. 20 corresponds to H=0. This indicates that a shadow reduction effect was achieved solely through embossing without forming a texture. Therefore, among the data points marked “○” and “Δ” in the region represented by the Expression 6 of H/(t×L×a)>0.0326 ln(t×L×a)−0.0305, data points marked “○” within the range of t×L×a <1.8, which corresponds to data from embossing alone, are not compatible with the findings of the study conducted by the inventors of the present disclosure based on the formation of textures derived from the properties of reflected light described above.

Similarly, based on the above results, the inventors of the present disclosure concluded that the range within which sink marks completely disappear across the entire plate portion 2 of the test piece 200 to obtain a reliable effect of reducing shadowing from sink marks is represented by the following expressions:

H/(t×L×a)>0.0425 ln(t×L×a)−0.027 . . . (Expression 8); and

t×L×a≥1.8 . . . (Expression 9).

### Supplemental Findings

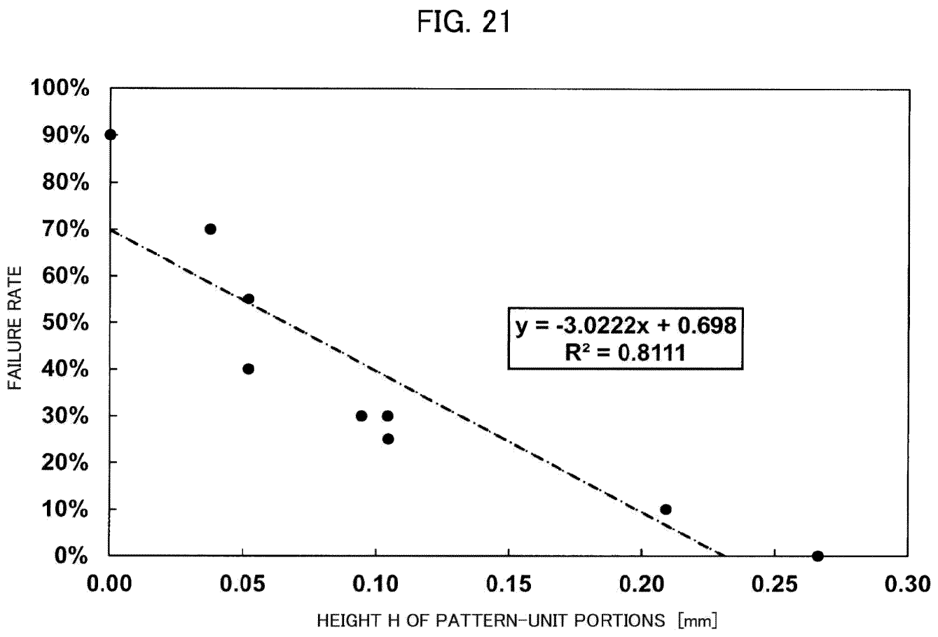

The inventors of the present disclosure were able to obtain the results shown in FIG. 21 as supplemental findings to those obtained from the Expressions 6, 7, and 8. FIG. 21 is a graph showing the results of a survey conducted on a plurality of subjects, inquiring whether the subject found the sink marks to be obtrusive or not based on test pieces 200 formed under various conditions for producing the pattern-unit portions 110 and subjected to embossing, as described above. All parameters other than the height H of the pattern-unit portions 110, such as the shape and material of each test piece 200 and the molding conditions, were kept constant. The selected subjects consisted of twenty personnel who are routinely involved in the manufacturing of molded parts.

In the graph of FIG. 21, the horizontal axis x represents the height H of the pattern-unit portions 110, while the vertical axis y represents the failure rate (the percentage of observers who answered that the sink marks were obtrusive). As shown in the graph, the failure rate decreases as the height H of the pattern-unit portions 110 increases. The approximation of the correlation between y=failure rate [%] and x=height H [mm] of the pattern-unit portions 110 is y=−3.0222x+0.698, with a coefficient of determination R² of 0.8111. This result is consistent with the trend shown in FIG. 20. That is, when comparing the experimental results for the same value on the horizontal axis (i.e., the same t×L×a value), the results shift in the order “×”→“Δ”→“○” as the value of the vertical axis (i.e., the H/(t×L×a) value) increases.

As described above, the inventors of the present disclosure identified the parameters H, t, L, and a as critical for making sink marks less visually noticeable and were able to formulate relationships for controlling the strength of the effect for reducing a deterioration in the aesthetic appearance of resin molded products. From these results, the inventors identified a new method for designing the surface profile of a resin molded product aimed at achieving this deterioration reducing effect.

### Advantageous Effects of the Present Embodiment

As described above, the inventors of the present disclosure molded test pieces 100 and 200 having the plate portion 2 and upstanding portions 3 under various conditions. After molding, the inventors performed surface finishing while varying various parameters and conducted sensory evaluations on the appearance of sink marks after this finishing. From these findings, the inventors discovered that forming texture as a surface finishing process (i.e., a texture consisting of the multiple pattern-unit portions 110, each having an appropriate height H, arranged in rows on the outer surface of the plate portion 2) was effective in reducing the obtrusive appearance of sink marks produced in the plate portion 2.

In a case where the plate portion 2 is simply finished as a smooth surface, specularly reflected light is only incident on a user's eye under specific relative positions between the light source and the user's eye. Consequently, shadows caused by the presence of sink marks become clearly apparent visually. In contrast, in a case where multiple pattern-unit portions 110 are arranged on the surface of the plate portion 2, where each pattern-unit portion 110 has a predetermined concave/convex shape as described above, specularly reflected light is generated from each projection or depression of the pattern-unit portions 110, and all of this light is incident on the user's eye. As a result, the entire plate portion 2 on which the pattern-unit portions 110 are arranged becomes brighter overall, reducing shadows caused by the presence of sink marks.

The inventors discovered that sink marks in the plate portion 2 could be less visually noticeable through a specific structure that satisfies the following conditions:

H/(t×L×a)>0.0326 ln(t×L×a)−0.0305 . . . (Expression 6); and

t×L×a≥1.8 . . . (Expression 7), wherein

H represents the height of the pattern-unit portions 110, t represents the wall thickness of the plate portion 2, L represents the maximum wall thickness of the upstanding portions 3, and a represents the shrinkage rate of the resin.

According to the present embodiment, sink marks can be made visually less recognizable by performing the surface finishing that satisfies the numerical range conditions described above. As a result, a deterioration in the aesthetic appearance can be reduced, thereby reducing a deterioration in marketability.

Further, the inventors of the present disclosure discovered that an effect capable of sufficiently obscuring sink marks produced in the plate portion 2 could be obtained by performing surface finishing such that the height H of the pattern-unit portions 110, the wall thickness t, the maximum wall thickness L, and the shrinkage rate a of the resin are within the range defined by the following expression:

H/(t×L×a)>0.0425 ln(t×L×a)−0.027 . . . (Expression 8).

In the present embodiment, sink marks can be made sufficiently difficult to perceive by performing the surface finishing that satisfies the above numerical range conditions. A deterioration in marketability can be reliably reduced.

Further, in the present embodiment, performing embossing on the pattern-unit portions 110 can diffuse specularly reflected light generated at the convexes/concaves in each pattern-unit portion 110. As a result, the presence of shadows caused by the sink marks is further diminished, reliably making the sink marks even more difficult to perceive.

Still further, in the present embodiment, the pattern-unit portions 110 have curved surfaces such as partial surfaces of a sphere or ellipse, which curved surfaces can produce specularly reflected light over a wide area. All of this light entering the user's eye makes it reliably difficult for the user to perceive sink marks visually. Specifically, arranging multiple curved surfaces adjacent to one another with no gaps therebetween as the pattern-unit portions 110 can eliminate any flat surfaces viewed in a direction perpendicular to the surface of the plate portion 2, thereby increasing the effect of concealing sink marks.

### Variations and Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

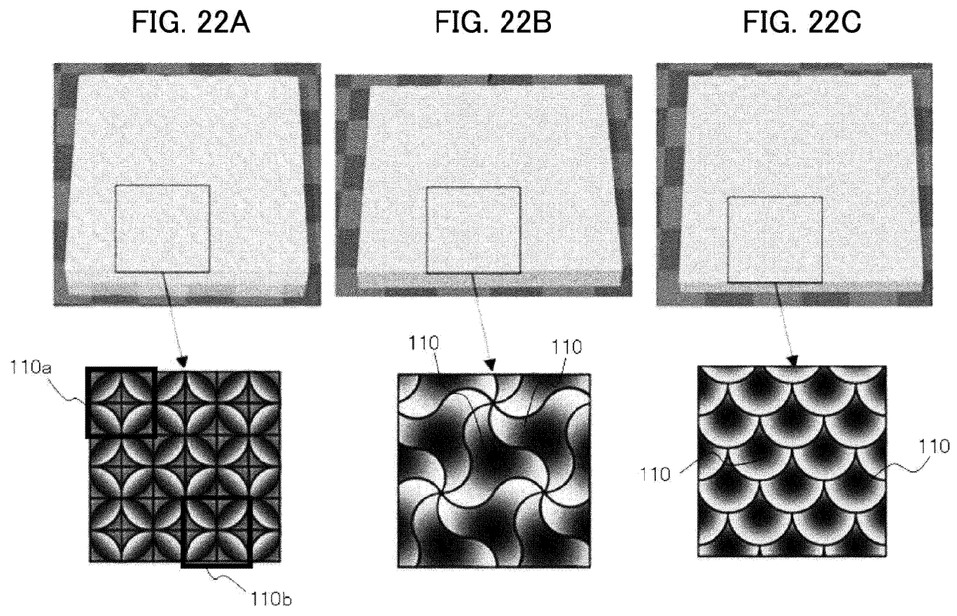

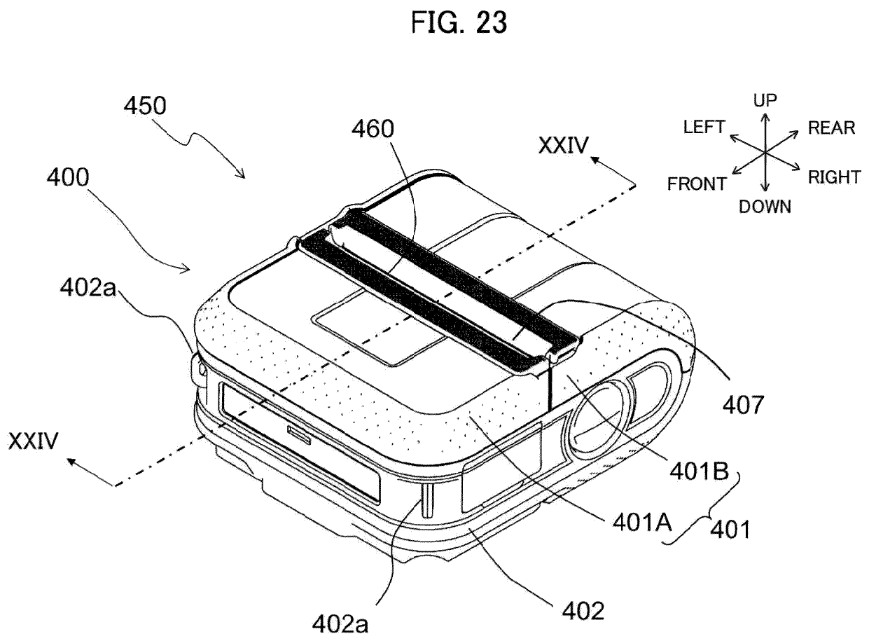

For example, FIGS. 22A through 22C are schematic diagrams illustrating sample variations of the concave/convex shapes of the pattern-unit portions 110.

FIG. 22A shows an example in which pattern-unit portions 110a are formed by combining partial spherical surfaces having different radii of curvature. In this case, each pattern-unit portion 110a contains multiple curved surfaces having mutually different curvatures. Therefore, the multiple curved surfaces of the pattern-unit portions 110a can generate specularly reflected light over a wide area so that sink marks are difficult to perceive visually. Since the pattern-unit portions 110a formed on the outer surface of the plate portion 2 are designed to have the same shape as each other, a portion 110b specified by a square border in FIG. 22A may be determined to be one pattern-unit portion 110a.

FIG. 22B shows an example in which the contour shape of each pattern-unit portion 110 is appropriately designed using partial spherical surfaces having a single radius of curvature. FIG. 22C shows an example in which the contours of the pattern-unit portions 110 are emphasized by creating steps in the direction perpendicular to the plane of the plate portion 2 when the pattern-unit portions 110 are arranged.

Although not shown in the drawings, a planar portion having a flat surface may be further formed on the plate portion 2 between every two neighboring pattern-unit portions 110. In this case, rather than two pattern-unit portions 110 having curved surfaces being arranged directly adjacent to each other, the planar portion is interposed between the two adjacent pattern-unit portions 110. This arrangement can reduce manufacturing costs by making surface finishing easier than when every two neighboring pattern-unit portions 110 are directly adjacent to each other.

### Second Embodiment

Next, a second embodiment of the present disclosure will be described with reference to FIGS. 23 through 25. This embodiment pertains to a printing device having a resin part molded according to the method described above in the first embodiment.

### Overall Configuration of the Printing Device

A overall configuration of a printing device 450 according to the second embodiment will be described with reference to FIGS. 23, 24, and 25. In the following description, the lower-right direction, upper-left direction, upper-right direction, lower-left direction, upward direction, and downward direction in FIG. 23 are defined as the right, left, rear, front, top, and bottom, respectively.

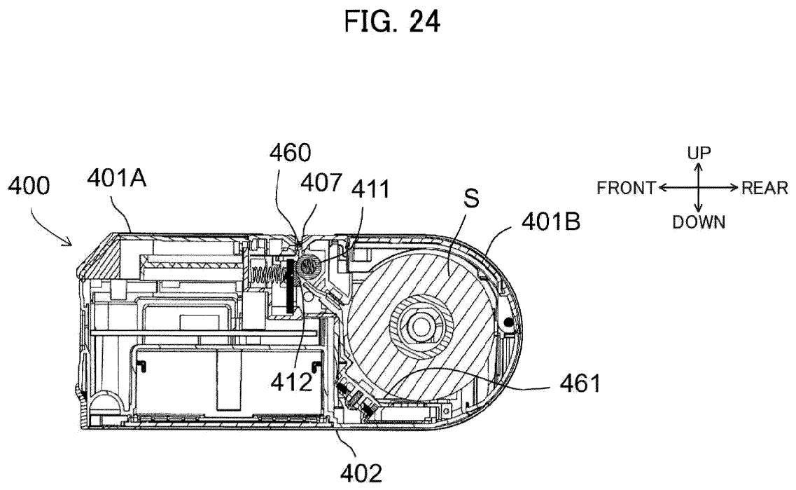

The printing device 450 illustrated in FIGS. 23 and 24 is configured to perform printing of print data received from an external device (not illustrated), such as a PC terminal or a mobile phone, on a roll paper S. A battery (not illustrated) can be used as a power supply for driving the printing device 450.

The printing device 450 includes a substantially box-shaped housing 400 made of a resin material, for example. The housing 400 constitutes the outer casing of the device. The housing 400 includes a top cover 401 constituting an upper portion of the outer casing of the device, and a bottom cover 402 constituting a bottom portion of the outer casing of the device. The top cover 401 includes a fixed portion 401A, and an openable lid 401B.

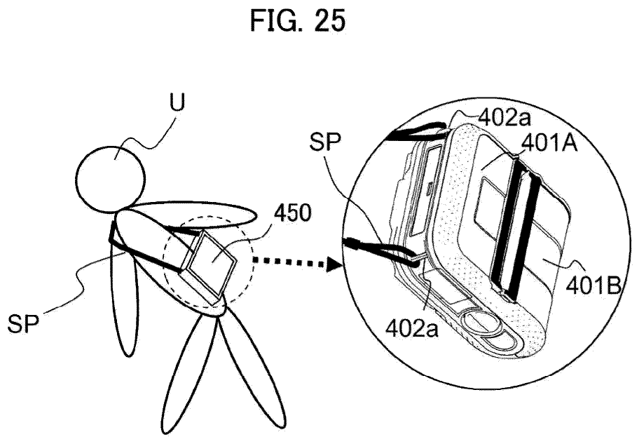

A pair of left and right insertion parts 402a are arranged on a front end portion of the bottom cover 402. As illustrated in FIG. 25, a strap SP can be inserted into these insertion parts 402a. Then, by hanging the strap SP over the shoulder or neck or by attaching the strap SP to a belt on a waist, an operator U can easily carry and use the battery-powered printing device 450 in various locations, including outdoors.

A roll accommodating compartment 461 is arranged beneath the openable lid 401B of the top cover 401. The roll paper S is accommodated in the roll accommodating compartment 461 such that the roll paper S is rotatable about its axis inside the roll accommodating compartment 461. Through this configuration, the roll paper S can be continuously supplied from the roll accommodating compartment 461. Further, an outlet 407 is formed in a general front-rear center region of the top cover 401 for discharging the printed roll paper S.

A platen roller 411 is rotatably supported by the openable lid 401B. The platen roller 411 is configured to convey the roll paper S while the openable lid 401B is in a closed state. A thermal line head 412 is disposed in the housing 400 near a front-rear center thereof. When the openable lid 401B is in the closed state described above, the thermal line head 412 contacts the platen roller 411 with a prescribed contact pressure.

### Operations of the Printing Device

To perform printing with the printing device 450 having the configuration described above, an external device such as a PC terminal or mobile phone transmits print data to the printing device 450 via wireless communication. In response to a drive force from a motor, the platen roller 411 rotates and draws the roll paper S out from the roll accommodating compartment 461. The roll paper S drawn from the roll accommodating compartment 461 is guided to a nip area between the platen roller 411 and the thermal line head 412. The thermal line head 412 prints a desired pattern on the roll paper S inserted between the thermal line head 412 and the platen roller 411 based on the print data described above. The roll paper S is then discharged from the housing 400 through the outlet 407. Fixed teeth 460 are fixed on the inside of the outlet 407 in a line extending along the outlet 407. At this time, the operator U can manually cut off the end of the roll paper S, which has been printed and discharged from the outlet 407 as described above, using the fixed teeth 460.

Significance of Applying the Present disclosure to Components of the Printing Device

As illustrated in FIG. 25, some components of the printing device 450 according to this embodiment may come into contact with the body of the operator U under certain modes of usage, such as during operation and transport. In this example, the housing 400 corresponds to such a component that may contact the body of the operator U, and is configured as a resin molded product. Such components are sometimes formed of flexible elastomers, for example.

Here, elastomers tend to generate a large amount of CO₂ during waste treatment. Therefore, more consideration has been given in recent years to using resin molded products in place of elastomers even for such components. When using resin molded products, resins with a black appearance are thought to be preferable from the recent perspective of promoting recycling. However, sink marks produced during molding in particular tend to be more noticeable when using black resin than when using lighter colored resins such as a white resin. Hence, the method described above in the first embodiment is particularly effective.

In the printing device 450 of the second embodiment, the housing 400 is formed according to the technique described above in the first embodiment since the housing 400 is a resin molded part, which is increasingly being considered as an alternative to elastomers owing to the above circumstances. That is, by forming the pattern-unit portions 110 that satisfy the Expressions 6 and 7 on the housing 400, the surface process described above is applied to counteract a potentially significant deterioration in aesthetic appearance due to sink marks. This ensures the recyclability of components constituting the printing device 450 while reducing a deterioration in aesthetic appearance, which in turn can reduce a decline in marketability.

### Third Embodiment

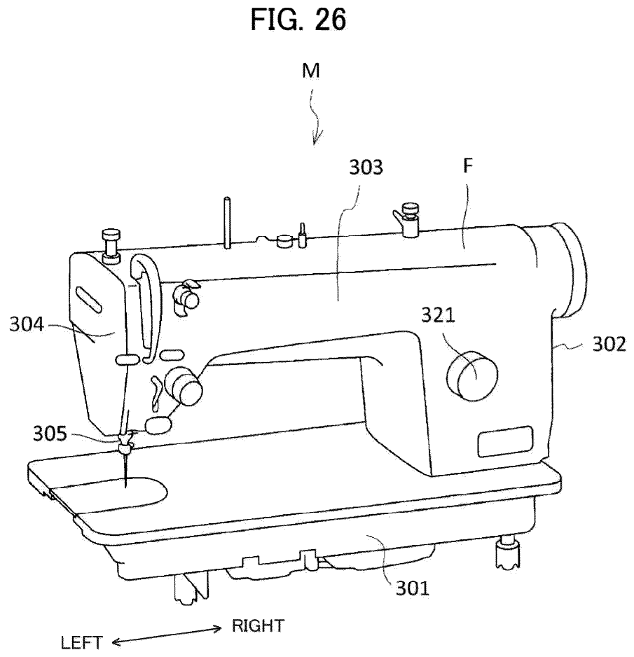

A third embodiment of the present disclosure will be described next with reference to FIG. 26. This embodiment pertains to a sewing machine having a resin component molded according to the method described in the first embodiment.

FIG. 26 depicts a sewing machine M according to the third embodiment. The sewing machine M has a bed portion 301, a post portion 302, an arm portion 303 extending leftward from the top of the post portion 302, and a head portion 304 located on a left end of the arm portion 303.

The bed portion 301 has internal components such as a thread-cutting mechanism (not illustrated) and a rotary hook (not illustrated). A bobbin around which a lower thread is wound is detachably mounted on the rotary hook. The arm portion 303 internally houses an upper shaft (not illustrated) driven by a sewing machine motor. The head portion 304 has a needle bar driving mechanism (not illustrated) that vertically drives a needle bar 305 via the upper shaft.

The sewing machine M also has a feed adjustment mechanism (not illustrated) that can regulate the feed amount and feed direction of a fabric being sewn. This feed adjustment mechanism includes a feed adjustment dial 321. The feed adjustment dial 321 is disposed on a frame F of the post portion 302 so that the feed adjustment dial 321 can be advanced and retracted relative to the frame F.

In the sewing machine M having the above configuration, resin molded products made as described in the first embodiment can be used for at least portions of covers constituting the surfaces of the post portion 302, arm portion 303, and head portion 304. With this configuration, a deterioration in the aesthetic appearance of the sewing machine M can be reduced, thereby a decline in marketability being also reduced.

### Fourth Embodiment

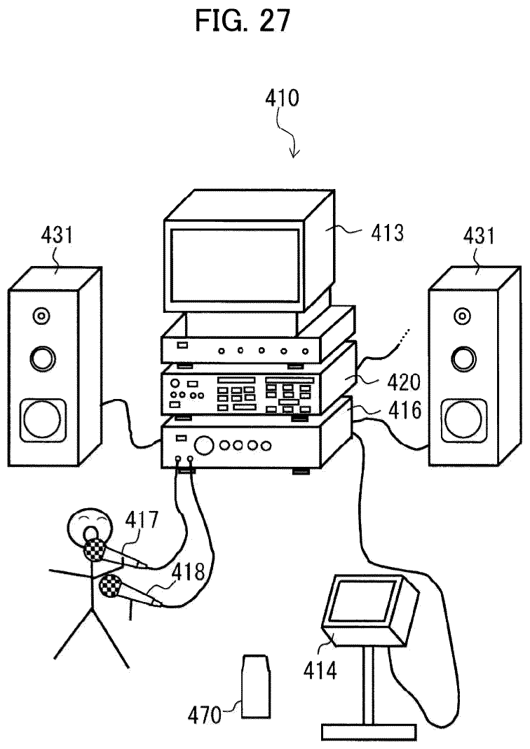

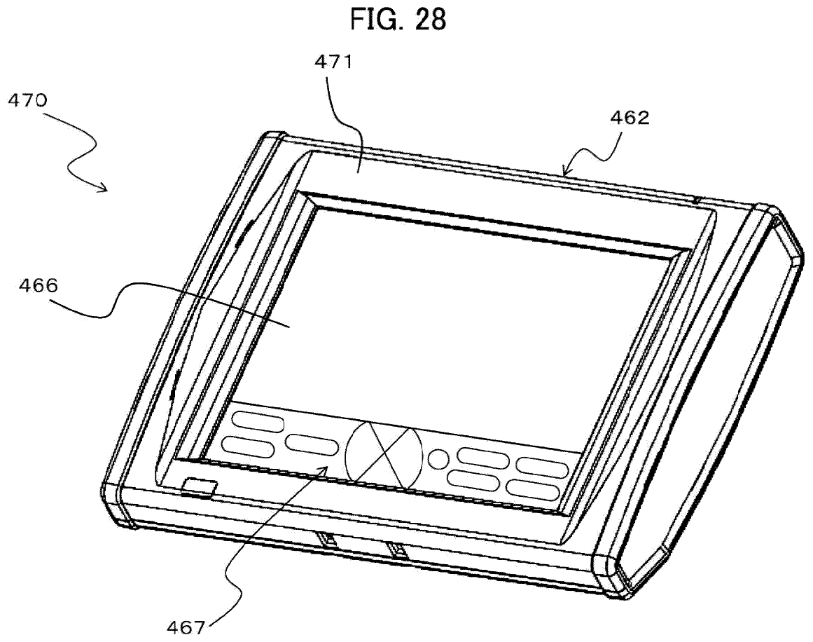

A fourth embodiment of the present disclosure will be described next with reference to FIG. 27. This embodiment pertains to a karaoke system having resin parts molded according to the method described above in the first embodiment.

FIG. 27 illustrates a karaoke system 410 according to the fourth embodiment. The karaoke system 410 includes a television monitor 413, a singer's monitor 414, a control device 420, an amplifier 416, and speakers 431.

The control device 420 performs song selection control and communication control. The song selection control involves selections of karaoke songs composed of musical sounds from multiple instruments, and reservations for song playback. The communication control involves transmitting a request signal to a server requesting transmission of a selected song and receiving song data for the song specified by the request signal. A remote control device 470 is used to operate the control device 420 remotely.

The amplifier 416 is configured to mix audio signals inputted from microphones 417 and 418 with playback signals of songs, adjust the audio-song volume balance, adjust echo and delay, amplify the mixed signal, control the pitch of the song being played, and control the treble and bass, for example.

The speakers 431 are configured to reproduce the amplified signal outputted from the amplifier 416 as sound.

In the karaoke system 410 having the above-described configuration, resin molded products described in the first embodiment can be used for at least portions of covers constituting the surfaces of the control device 420 and the amplifier 416, for example. This usage can reduce a deterioration in the aesthetic appearance of these components of the karaoke system 410, thereby reducing a decline in marketability.

### Fifth Embodiment

A fifth embodiment of the present disclosure will be described next with reference to FIG. 28. This embodiment pertains to the karaoke remote control device 470 described in the fourth embodiment when the remote control device 470 includes resin components molded according to the method described in the first embodiment.

The remote control device 470 according to the fifth embodiment illustrated in FIG. 28 includes a device body 462. A touchscreen 466 combining display and operation functions is disposed in a central position on the top surface of the device body 462. The touchscreen 466 is configured to display operation menus, song titles, and the like. When a user touches a prescribed display button with a fingertip, for example, the touchscreen 466 can transmit a corresponding operation command to the karaoke system 410 described above via infrared communication or other means. Additionally, various special-purpose buttons 467 are provided beneath the touchscreen 466 for performing such operations as halting playback, adjusting playback speed, and adjusting volume.

The device body 462 has a device housing 471 constituting the portion of the device body 462 excluding the touchscreen 466 and special-purpose buttons 467. The resin molded part described in the first embodiment can be used for at least a portion of the device housing 471. This usage can reduce a deterioration in the aesthetic appearance of the remote control device 470, thereby reducing a decline in marketability.

### Other Variation

Resin components molded according to the method described in the first embodiment may also be incorporated in a cutting device configured to cut a medium such as fabric along the outline of an image on the medium.

### Definition of Appearance Surfaces

In devices such as the printing device, sewing machine, karaoke system, karaoke remote control device, and cutting device described above, resin molded parts may be used as components that form the external appearance of the device. In such cases, the exterior surfaces of the resin molded parts, and particularly the exterior surface of the plate portion, are expected to be visible to customers in stores or online.

Components of a product primarily intended to form the exterior of the product are commonly referred to as “appearance parts.” The surfaces of the appearance parts of resin molded products designed under the expectation that these surfaces will be visible to customers are commonly defined as “appearance surfaces.”

However, resin molded products often include ribs and bosses to enhance strength and rigidity, and pawl-like features for the purpose of fixing the part. These elements are typically arranged on the back side of the appearance surface so as not to degrade the quality of the appearance surface.

### Remarks

The use of such terms as “perpendicular”, “parallel”, and “planar” in the above description are not intended to be taken in their strictest sense. In other words, the terms “perpendicular”, “parallel”, and “planar” may signify “substantially perpendicular”, “substantially parallel”, and “substantially planar” to allow for design and manufacturing tolerances and error.

Further, when dimensions and sizes are described as being “identical”, “equivalent”, or “different” in appearance in the above description, these terms are not intended to be taken in their strictest sense. In other words, the terms “identical”, “equivalent”, and “different” may signify “substantially identical”, “substantially equivalent”, and “substantially different” to allow for design and manufacturing tolerances and error.

In addition to what has already been described, the methods according to the embodiments and their variations described above may be used in suitable combinations.

Still further, although not illustrated individually, the invention according to the present disclosure may be implemented with various modifications, without departing from the spirit of the invention.

What is claimed is:

1. A resin molded product comprising:
a plate portion having a first surface and a second surface opposite each other, the first surface including a plurality of pattern-unit portions arranged in rows to form a pattern of concaves and convexes on the first surface, the first surface serving as an appearance surface of the resin molded product; and
a plurality of upstanding portions extending from the second surface of the plate portion,
wherein the following conditions are met:
H/(t×L×a)>0.0326 ln(t×L×a)−0.0305; and
t×L×a≥1.8,
in which:
H represents a height of the pattern-unit portions;
t represents a wall thickness of the plate portion;
L represents a maximum wall thickness of the plurality of upstanding portions; and
a represents a shrinkage rate of resin.

2. The resin molded product according to claim 1,
wherein the following condition is further met:
H/(t×L×a)>0.0425 ln(t×L×a)−0.027.

3. The resin molded product according to claim 1,
wherein the plurality of pattern-unit portions are embossed.

4. The resin molded product according to claim 1,
wherein each of the plurality of pattern-unit portions has a curved surface.

5. The resin molded product according to claim 4,
wherein each of the plurality of pattern-unit portions has another curved surface, curvatures of the curved surface and the another curved surface being different from each other.

6. The resin molded product according to claim 1,
wherein one of the plurality of upstanding portions is a boss protruding from the second surface of the plate portion.

7. The resin molded product according to claim 6,
wherein another one of the plurality of upstanding portions is a rib protruding from the second surface of the plate portion, the rib surrounding the boss.

8. A printing device comprising:
the resin molded product according to claim 1,
wherein the appearance surface of the plate portion of the resin molded product constitutes a part of an appearance surface of the printing device.

9. A sewing machine comprising:
the resin molded product according to claim 1,
wherein the appearance surface of the plate portion of the resin molded product constitutes a part of an appearance surface of the sewing machine.

10. A karaoke system comprising:
a control device;
an amplifier;
a remote control device for operating the control device remotely; and
the resin molded product according to claim 1,
wherein the appearance surface of the plate portion of the resin molded product constitutes at least one of:
a part of an appearance surface of the control device;
a part of an appearance surface of the amplifier; or
a part of an appearance surface of the remote control device.
